(19) United States
(12) Patent Application Publication
(10) Pub. No.: US 2007/0057935 A1
(43) Pub. Date: Mar. 15, 2007

(54) Information holding device and communication support device

(75) Inventor: Tomohito Takagi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/401,916

(22) Filed: Apr. 12, 2006

(30) Foreign Application Priority Data
Aug. 25, 2005 (JP) P2005-244858
Aug. 26, 2005 (JP) P2005-246872

(51) Int. Cl. G09G 5/00

(52) U.S. Cl. 345/211

(57) ABSTRACT

An information holding device includes: a storing portion that stores information; a transmitting portion that transmits the information; a sheet-like member having flexibility; and a detecting portion that detects a change in shape of the sheet-like member, wherein when a change in shape of the sheet-like member detected by the detecting portion satisfies a predetermined condition, the information stored in the storing portion is transmitted by the transmitting portion.

### CROSS-REFERENCE TO THE RELATED APPLICATION(S)

This application is based upon and claims a priority from prior Japanese Patent Applications No. 2005-244858 filed on Aug. 25, 2005, and No. 2005-246872 filed on Aug. 26, 2005, the entire contents of which are incorporated herein by reference.

### BACKGROUND

1. Technical Field

The present invention relates to an information holding device such as an electronic paper, or the like, for example, and a communication support device having a surface on which such information holding device can be loaded.

2. Related Art

As the method of communicating information between the users facing each other via PDA (Portable Digital Assistant), a cellular phone, or the like, the communication of information utilizing the infrared rays, for example, is carried out recently.

More particularly, when the user would like to transmit image data of a photograph stored in the user's cellular phone to the cellular phone on the other party, such user puts the user's cellular phone to oppose to the cellular phone on the other party as the destination, then chooses a menu “Infrared Transmission” by operating a key on the user's cellular phone, then chooses the to-be-sent photograph by a key operation, and then pushes a “decide” button, or the like to start the transmission.

However, since the information transmitting operation in the prior art is executed mainly by the key operation, such operation lacks immediacy and its operability is low.

Meanwhile, the electronic paper is known recently.

The electronic paper forms a sheet-like shape like a paper medium, and a shape alternation such as a curvature, or the like can be applied.

In the information holding device having a flexible member such as this electronic paper, or the like, normally it is supposed that, like the operation executed in the cellular phone, or the like in the prior art, the transmission of information held in this information holding device, or the like is made by the key operation or the handwriting by pen.

Also, various information can be printed/recorded with the development of the information processing technology. In the meanwhile, in order to execute further the process utilizing the information bore on the sheet-like medium such as the electronic paper or the paper medium, the user must take the operation of the information processing system to correspond to such process.

For example, in order to send the information bore on the paper medium (information formed like the paper medium) by electronic mail, the information recorded on the paper medium must be read by a scanner, or the like and then the read data must be sent as electronic mail. Also, when electronic data corresponding to the information recorded on the paper medium are present, such electronic data may be searched by any approach and then the electronic data may be sent. Further, in order to make the search of the electronic data easy, such a system has already been developed that information to identify the paper medium are held to correlate with the electronic data and the corresponding electronic data can be searched by inputting the information to identify the paper medium.

However, in any event the information processing system needs the operation of instructing the content of the information processing, and thus the degree of convenience for use is low.

### SUMMARY

According to an aspect of the invention, there is provided an information holding device including: a storing portion that stores information; a transmitting portion that transmits the information; a sheet-like member having flexibility; and a detecting portion that detects a change in shape of the sheet-like member, wherein when a change in shape of the sheet-like member detected by the detecting portion satisfies a predetermined condition, the information stored in the storing portion is transmitted by the transmitting portion.

### BRIEF DESCRIPTION OF THE DRAWINGS

FIG. 1 is a schematic view showing an example of an information holding device according to a first exemplary embodiment of the present invention;

FIG. 2 is a block diagram showing a configurative example of the information holding device according to the first exemplary embodiment of the present invention;

FIGS. 3A and 3B are views showing an operation example of the information holding device according to the first exemplary embodiment of the present invention;

FIG. 4 is an explanatory view showing an example of a change in an acceleration measured by an acceleration sensor with respect to time in the information holding device according to the first exemplary embodiment of the present invention;

FIG. 5 is a configurative block diagram showing an example of a communication support device according to a second exemplary embodiment of the present invention;

FIG. 6 is an explanatory view showing a sensed result of a touch sensor and an example of contact area in the communication support device according to the second exemplary embodiment of the present invention;

FIGS. 7A to 7C are explanatory view showing an example of changing states of the contact area in the communication support device according to the second exemplary embodiment of the present invention;

FIG. 8 is a block diagram showing a configurative example of an information processing system according to a third exemplary embodiment of the present invention;

FIG. 9 is an explanatory view showing an example of a shape altering operation applied to a sheet-like medium;

FIG. 10 is an explanatory view showing set examples of information processing contents in the information processing system according to the third exemplary embodiment of the present invention;

FIG. 11 is a flowchart showing an example of an operation of the information processing system according to the third exemplary embodiment of the present invention;

FIG. 12 is a block diagram showing another configurative example of the information processing system according to the third exemplary embodiment of the present invention; and

FIG. 13 is a schematic view showing a configurative example of a bending member contained in a displaying portion of an electronic paper as the information processing system according to the third exemplary embodiment of the present invention.

### DETAILED DESCRIPTION

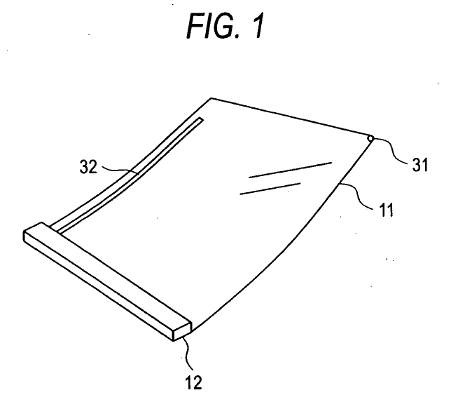

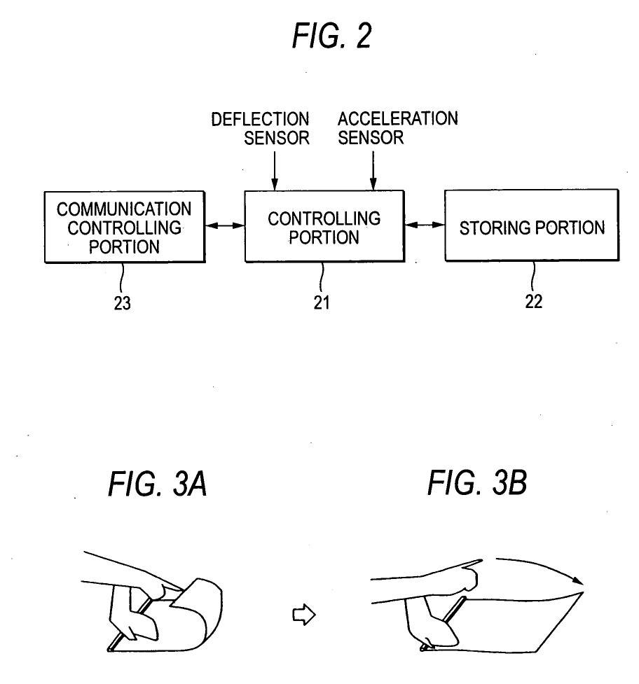

A first exemplary embodiment of the present invention will be explained with reference to the drawings hereinafter. As shown in FIG. 1, an information holding device according to this exemplary embodiment is constructed to include a display device 11 formed by utilizing a member having flexibility and shaped like a sheet, and a control device 12 connected to this display device 11. Also, as shown in FIG. 2, the control device 12 has a controlling portion 21, a storing portion 22, and a communication controlling portion 23.

The display device 11 of this exemplary embodiment is formed like an almost rectangular shape, and an acceleration sensor 31 for sensing an acceleration is provided at least to one side (e.g., one side in the longitudinal direction). Also, as a sensor for sensing a change in shape of the display device 11, a deflection sensor 32 for sensing a deflection (e.g., a strain gauge, or the like) is provided to a surface of the display device The display device 11 is a displaying portion of the so-called electronic paper, and the display devices utilizing the technology to rotate ink particles, the electrophoresis technology, the thermal rewritable technology, and the like, for example, are known. Here, any of the above devices may be employed. The display device 11 displays/outputs image data being input from the controlling portion 21 of the control device 12.

The controlling portion 21 is CPU, or the like that is operated in compliance with a program stored in the storing portion 22. The controlling portion 21 stores the information received from an external device via the communication controlling portion 23 in the storing portion 22. Also, the controlling portion 21 outputs the information stored in the storing portion 22 to the display device 11 to display. In addition, the controlling portion 21 causes a sensor to sense a deflection of the display device 11 as the sheet-like member, and sends/outputs the information stored in the storing portion 22 via the communication controlling portion 23 when a change of the deflection with respect to time satisfies a predetermined condition. An operation of the controlling portion 21 will be described in detail later.

The storing portion 22 contains RAM and ROM. The storing portion 22 holds the program executed by the controlling portion 21, and holds the information input from the controlling portion 21. Also, the storing portion 22 acts as a work memory of the controlling portion 21.

The communication controlling portion 23 is a wireless LAN device having an antenna, for example, and transmits the information to a destination instructed based on the instruction input from the controlling portion 21. Also, the communication controlling portion 23 receives the information by demodulating a signal that arrives at an antenna, and outputs the received information to the controlling portion 21.

The acceleration sensor 31 catches a time change of the deflection of the display device 11 as the sheet-like medium as an acceleration. That is, as shown in FIGS. 3A and 3B, the acceleration sensor 31 senses a change of the deflection with respect to time based on an acceleration generated in the process (FIG. 3B) whereby the display device 11 goes back to its original shape because of its elasticity after the user bends the display device 11 (FIG. 3A) and releases it. The acceleration sensor 31 outputs the information of the sensed acceleration to the controlling portion 21 while such sensor is turned ON by the acceleration sensor 31.

The deflection sensor 32 is a switch that is turned ON when the display device 11 is bent to exceed a predetermined amount of deflection but is turned OFF in other circumstances. An ON/OFF signal of the deflection sensor is output to the controlling portion 21.

Now, an operation of the controlling portion 21 will be explained hereunder. The controlling portion 21 turns ON the acceleration sensor 31 when the signal input from the deflection sensor 32 is turned ON. Then, after the acceleration sensor 31 is turned ON, the controlling portion 21 receives in seriatim an input of the acceleration information from the acceleration sensor 31 and then records the acceleration information. Then, the controlling portion 21 examines based on the record whether or not a change of the acceleration information with respect to time agrees with the predetermined condition.

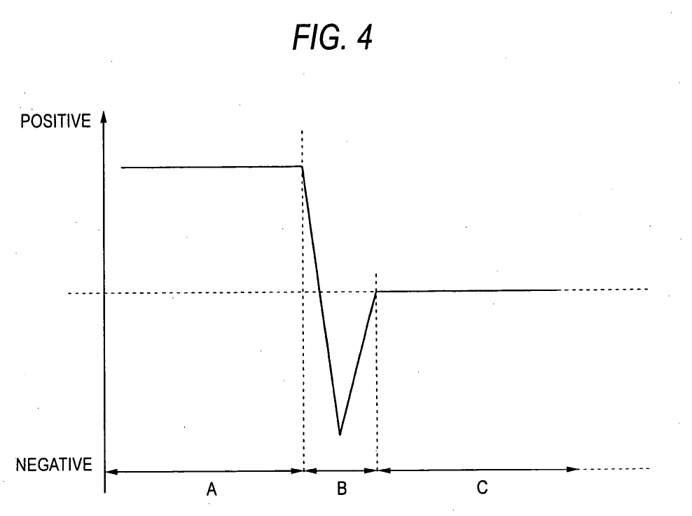

For example, in sensing that the other party side of the display device 11 as the sheet-like medium is bent to this side and then released, suppose that the acceleration sensor 31 is provided to the side of the display device 11 on the other party side. Then, the above condition is given as such a condition that a change in the acceleration sensed by the acceleration sensor 31 with respect to time corresponds to a change in the acceleration until the other party side lands on the desk top from its bent state. In this case, the other party side of the display device 11 is pulled by gravity. Therefore, when a change in the acceleration sensed by the acceleration sensor 31 with respect to time contains an interval (A) where the other party side of the display device 11 has a gravity equivalent to a gravitational acceleration, an interval (B) where the other party side arrives at the desk top and a negative gravity is generated, and an interval (C) where the acceleration becomes “0”, as shown in FIG. 4, the controlling portion 21 decides that the condition is satisfied and then transmits/outputs the information stored in the storing portion 22 via the communication controlling portion 23.

Here, a change in the deflection of the display device 11 with respect to time is sensed by the acceleration. But a change in the deflection of the display device 11 with respect to time may be sensed by a deflection sensor that outputs a signal in response to an amount of deflection. Also, a change in the deflection of the display device 11 with respect to time may be sensed by using a position sensor. For example, a marker is put at least to one point on opposing sides of the display device 11 respectively, and then the deflection may be sensed according to relative positions between the markers.

Also, in the explanation made up to now, an example in which the device itself containing the sheet-like member such as the electronic paper, or the like senses/processes the deflection of the sheet-like member is described. In place of this, a process of transmitting the information may be executed in the device on which the sheet-like member can be loaded, for example. Therefore, this example will be described hereunder.

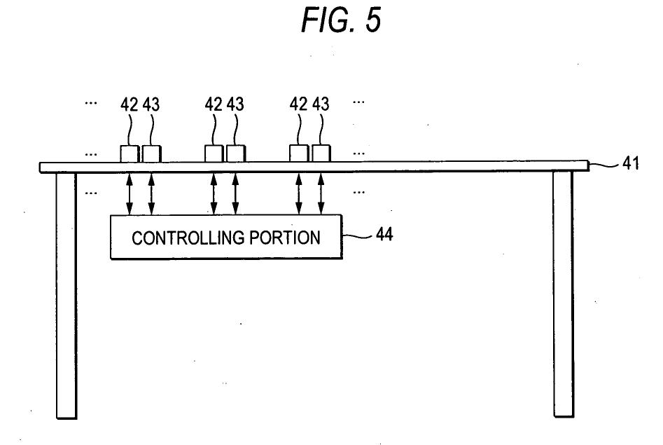

A communication support device 4 according to a second exemplary embodiment of the present invention is a table, for example, as shown in FIG. 5, and is constructed to include a top portion 41 acting as a loading surface, sensors 42 arranged on the top portion 41, communication controlling portions 43, and a controlling portion 44.

In this exemplary embodiment, explanation will be made hereunder under the assumption that the information holding device for transmitting/receiving the information is similar to the electronic paper shown in FIG. 1. Here, suppose that the communication controlling portion 23 of the control device 12 executes the communication using an electromagnetic wave radiated from the reader-writer side, like the so-called non-contact IC card, and also a communication effective range is set within a range of almost an electronic paper size.

The sensor 42 is a contact sensor. The sensor 42 is turned ON when the object to be loaded on the top portion 41 such as electronic paper, document, computer, user's finger, or the like touches this sensor, while the sensor 42 is turned OFF when the object does not touch this sensor. In this exemplary embodiment, plural sensors 42 are arranged on the top portion 41 in a matrix fashion. Accordingly, a shape of an area with which the object such as the electronic paper, or the like, for example, comes into touch is sensed.

A plurality of communication controlling portions 43 are arranged on the top portion 41 in a matrix fashion, like the sensors 42. This communication controlling portion 43 acts as the reader-writer of the so-called non-contact IC card, and transmits/receives the information to/from the information holding device.

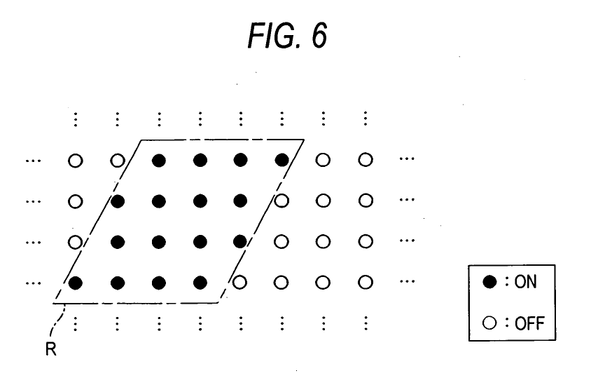

Also, the controlling portion 44 senses an area with which the object comes into touch, from the information input from respective sensors 42. Map information (FIG. 6) representing ON areas is generated according to an alignment of the sensors 42, and the sensors 42 that are turned ON sense neighboring areas as contact areas (R) on this map information respectively.

Then, the controlling portion 44 acquires the information in which the contact areas are changed and which are held in the information holding device, based on a time change of the contact areas and then executes a predetermined transmitting process concerning the acquired information.

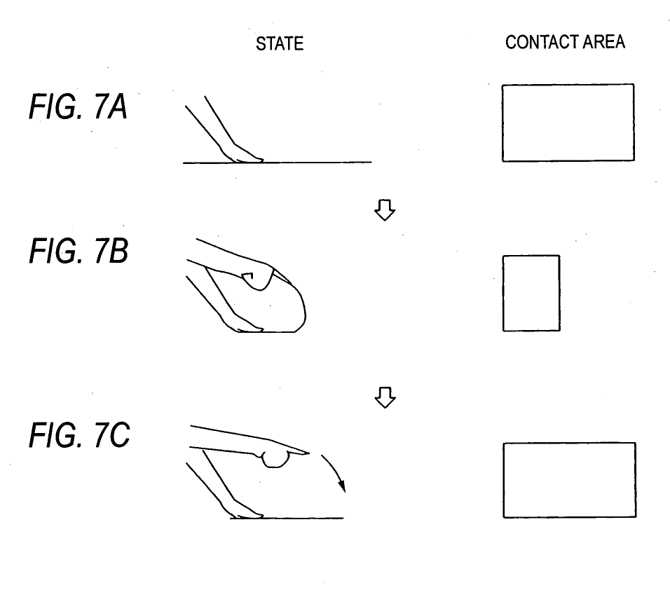

In this exemplary embodiment, like the first exemplary embodiment, explanation will be made by using the case where the user instructs to transmit the information by bending the display device 11 and then releasing it, as shown in FIGS. 3A and 3B, as an example. In this case, as shown in FIGS. 7A to 7C, a change in contact areas with respect to time is given such that at first the overall display device 11 touches the desk top (FIG. 7A), then the contact area is narrowed in the bending direction when the display device 11 is bent (FIG. 7B), and the overall display device 11 is returned to a state that such device touches the desk top when the display device 11 is released (FIG. 7C). In FIGS. 7A to 7C, in order to facilitate the understanding, the user's work (left column) and a change in the contact area (right column) are illustrated to correlate with each other.

Under the condition that, as shown in FIGS. 7A to 7C, the contact area changes with respect to time such that the area decreases once and then returns to its original state, the controlling portion 44 acquires and holds the information stored in the storing portion 22 of the information holding device by controlling the communication controlling portions 43 within the contact area. Then, for example, the controlling portion 44 controls the communication controlling portions 43 outside of the contact area to send out the held information.

Therefore, when the user loads the electronic paper that holds the information therein on the top portion 41 and then executes the operations shown in FIGS. 3A and 3B, the controlling portion 44 acquires the information held in the electronic paper and then transmits the acquired information to another electronic paper loaded on the top portion 41.

Here, the controlling portion 44 sends out the held information by controlling the communication controlling portions 43 outside of the contact area. In this event, when the controlling portion 44 can sense the direction along which the contact area is reduced, the controlling portion 44 may send out the held information by not controlling all the communication controlling portions 43 outside of the contact area but controlling the communication controlling portions 43 that exist in this direction. In this case, the information can be transmitted only to the user who is located in the direction toward which the bent side of the electronic paper is directed.

The controlling portion 21 of the information holding device when receives the information sent out from the communication controlling portions 43 stores such information in the storing portion 22 and cause the display device 11 to display the information.

According to the first and second exemplary embodiments, in the information holding device such as the electronic paper, or the like having the sheet-like member, the information transmitting control is executed when the operations to bend the sheet-like member and then release (or flick) it are taken as the information transmitting operation. Therefore, immediacy of the operation can be improved and its operability can be enhanced. Here, explanation is made by taking the deflection as an example of a change in shape of the display device 11. But a change in shape of the display device 11 is not limited to this. For example, folding, or the like of the display device 11 may be sensed.

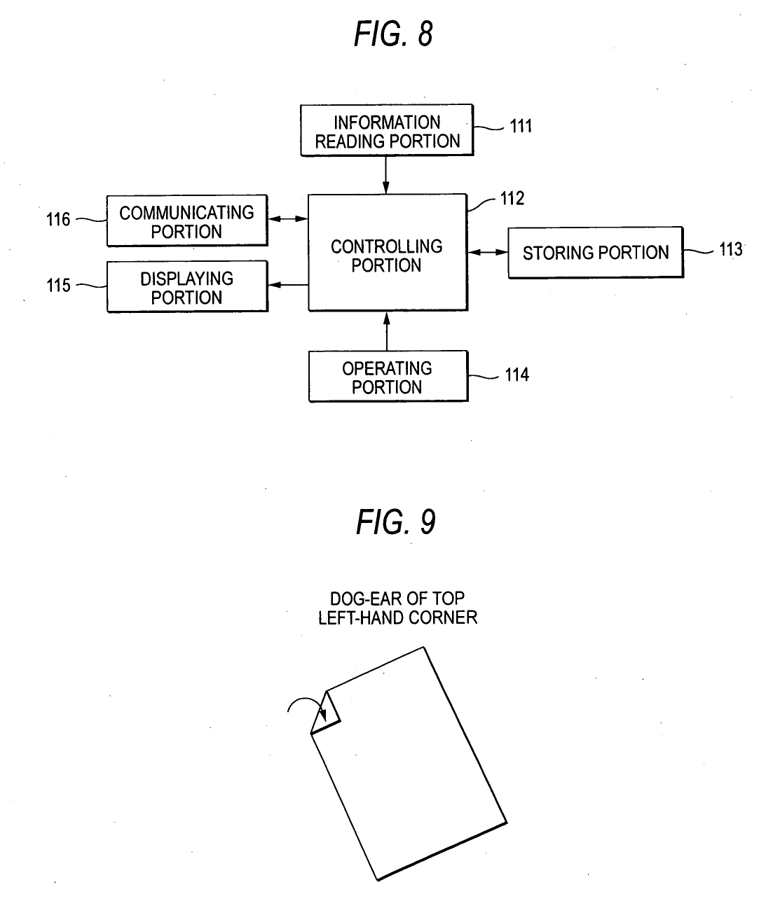

A third exemplary embodiment of the present invention will be explained with reference to the drawings hereunder. As shown in FIG. 8, an information processing system according to the third exemplary embodiment of the present invention is a constructed to include an information reading portion 111, a controlling portion 112, a storing portion 113, an operating portion 114, a displaying portion 115, and a communicating portion 116.

The information reading portion 111 is a scanner, or the like, for example, and reads optically the information bore on the sheet-like medium loaded on the original table in response to the user's reading operation. This information reading portion 111 outputs the image data obtained by the reading to the controlling portion 112.

The controlling portion 112 is a program control device such as CPU, or the like, and executes processes in compliance with the programs stored in the storing portion 113. This controlling portion 112 carries out a process of recognizing the contents of the shape altering operation, which is applied to the read sheet-like medium, based on the image data read by the information reading portion 111, and a process of executing an information processing determined previously in response to this recognized shape altering operation with regard to the information bore on the read sheet-like medium. Examples of the contents of particular processes in the controlling portion 112 will be explained in detail later.

The storing portion 113 is constructed to contain a memory device such as RAM, ROM, or the like and a computer-readable storing medium such as a hard disk, or the like. The programs executed by the controlling portion 112, operation setting parameters of the programs, etc. are held in the storing portion 113. Also, the storing portion 113 acts as a work memory of the controlling portion 112.

The operating portion 114 consists of buttons, a touch panel, or the like, and outputs contents of the operation instructed by the user to the controlling portion 112. The displaying portion 115 is a display, or the like, and displays the information to the user in compliance with the instruction input from the controlling portion 112.

The communicating portion 116 is a network interface, or the like, and transmits the information to a designated destination in compliance with the instruction input from the controlling portion 112. Also, this communicating portion 116 receives the information coming via the network, and outputs such information to the controlling portion 112.

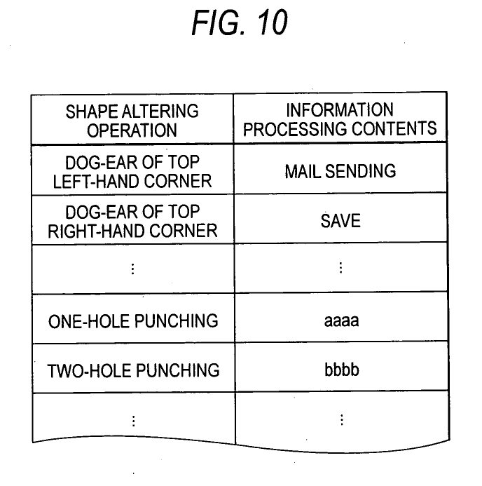

In this exemplary embodiment, as the operation setting parameters of the programs, contents of the shape altering operations applied to the sheet-like medium and contents of the information processing are held in the storing portion 113 to correlate with each other. Here, in the operation setting parameter, the shape altering operation is the operation of folding a corner of the sheet-like medium, tearing a corner portion, punching a hole, and the like, for example, as shown in FIG. 9. Also, in the operation setting parameter, as shown in FIG. 10, the information processing contents are held such that the data are sent by mail when a top left-hand corner of the sheet-like medium is turn down, the data are saved when a top right-hand corner is turn down, . . . In addition, in the punching operation, contents of the information processing may be correlated with the number and the positions of punched holes.

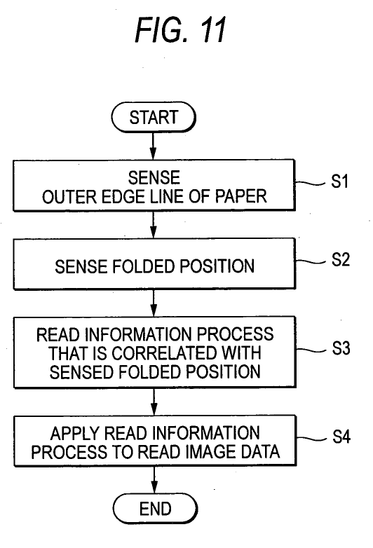

The controlling portion 112 recognizes the shape altering operation applied to the read sheet-like medium, based on the image data obtained from the information reading portion 111. In this recognition, for example, as shown in FIG. 11, an imaging process of extracting an outer edge line of the image data that the information reading portion 111 outputs is executed (S1). Then, while using an outermost edge line out of edge lines as an outer edge line of a paper, it is decided whether or not the four corners (edge portions) of the outer edge line of the paper are turned down, or the like respectively. Then, an orientation of the paper is sensed by grasping the contents being set on the paper by virtue of the character recognizing technology (OCR), or the like. Then, it is decided to which one of the top left-hand corner, the top right-hand corner, the bottom left-hand corner, and the bottom right-hand corner of the paper the position that is subjected to the shape altering process corresponds, based on the sensed result and the folded position, or the like grasped by the outer edge line (S2). Then, the information processing contents that are set in the operation setting parameters to be correlated with the position of the corner portion that underwent the folding, or the like are read (S3). Then, the information processing having the contents read in the process S3 is applied to the image data read by the information reading portion 11 (S4).

For example, when the information processing content is set to indicate that the electronic mail should be sent when the top left-hand corner of the paper is turn down, the top left-hand corner of the paper on which the information to be sent by the electronic mail is printed is folded and then read by the information reading portion 111. The controlling portion 112 examines to which corner of the paper the folded corner corresponded, based on the outer edge line of the image of this read paper. Since it is recognized herein that the top left-hand corner of the paper was turn down, a process of sending the electronic mail is started as the information processing content that is correlated with the folded position, and it is displayed on the displaying portion 115 that the destination should be designated. Then, when the operation of designating the destination is given from the operating portion 114, the image data read by the information reading portion 111 is sent to the destination designated by the designating operation via the communicating portion 116.

Also, in the case where the hole should be punched, when a circular (hole) image is contained in vicinity of the predetermined punched position on the paper, it is decided that the hole is punched in the corresponding position. For example, it should be counted by the image recognizing process how many circular images are contained in a predetermined range of the left end of the paper, and then a predetermined information processing should be executed in response to the counted number. In this case, since the image recognizing process is known widely, its detailed explanation will be omitted herein.

In this manner, according to this exemplary embodiment, the information processing content for the information bore on the paper can be designated by applying previously the shape altering operation (folding, punching, or the like), or the like to the paper, and then the corresponding information processing can be executed by shooting the paper the shape of which is altered by the imaging device such as a scanner, or the like. In other words, in this example, an amount of operation using the key, and the like in the information processing system can be reduced and an extent of convenience can be improved.

Also, when the information stored in the storing portion 113 is printed on the paper as print object information, a peculiar paper medium identifier may be issued and then this issued paper medium identifier may be set to the paper. At this time, the print object information and the paper medium identifier may be stored in the storing portion 113 to correlate with each other. For example, a database for correlating the paper medium identifier issued when the printing instruction is issued with every information stored in the storing portion 113 may be generated, and then such database may be stored in the storing portion 113.

Also, as the method of setting the paper medium identifier to the paper, a radio tag such as RF-ID, or the like may be attached previously and then the issued paper medium identifier may be stored in the radio tag, or the paper medium identifier may be converted into the coded image such as a bar code, or the like and then the coded image may be formed on the paper.

When doing this, if the information bore on the paper cannot be obtained as the image data but the paper medium identifier correlated with this paper can be read, the information processing can be executed by using the data stored in the storing portion 113 to correspond to the paper medium identifier.

As a result, it is not needed to pick up the image of the information bore on the paper. For example, the information processing content can be set to the shape alternation of the paper such as folding the paper in two, folding the paper obliquely, crumpling the paper into a ball, or the like.

In this case, the information reading portion 111 may be constructed to contain a camera for reading the shape, and a radio tag reader. Also, when the paper medium identifier is formed as the coded image, the radio tag reader is not always required because the coded image can be read by the camera. The controlling portion 112 acquires the paper medium identifier read by the information reading portion 111, and the shape image of the paper.

The controlling portion 112 executes the image processing to recognize the shape of the paper here, and reads the information processing content that is set previously to correspond to the paper shape recognized by the image processing. Also, the controlling portion 112 reads the data that is stored in the storing portion 113 to correlate with the acquired paper medium identifier. Then, the information processing read from the operation setting parameter is applied to the data read here.

For example, in the case where the information processing to erase the data is correlated with the shape that is crumpled into a ball, when such shape is recognized as a circle (solid sphere) as the result of the shape recognition in the controlling portion 112, the data that is correlated with the acquired paper medium identifier in the storing portion 113 are erased.

In this case, since the information processing regarding the shape recognition herein is the widely known processing to sense the shape in response to a coincidence between a predetermined pattern and this shape, or the like, its detailed explanation will be omitted herein.

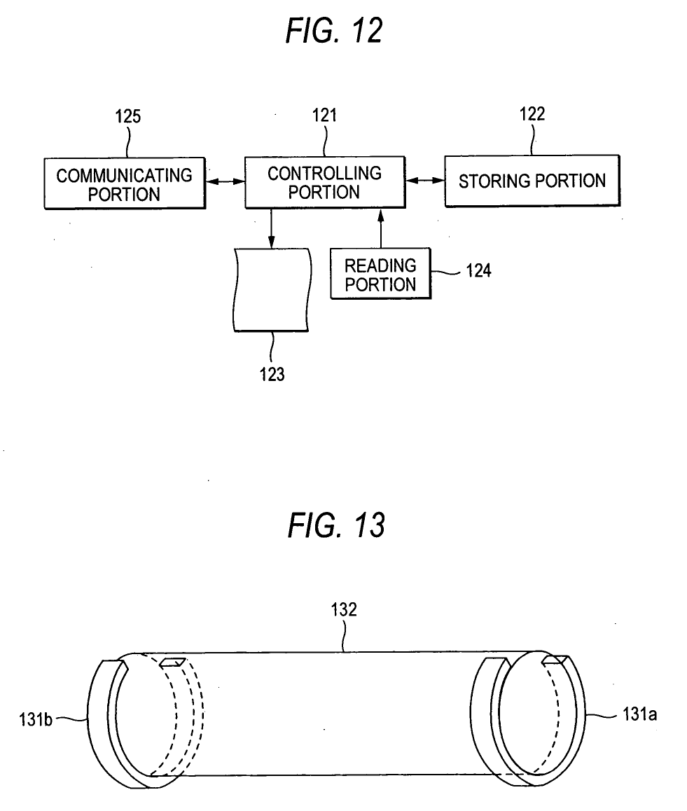

Further, the information processing system of this exemplary embodiment may be provides as the so-called electronic paper. The electronic paper according to another aspect of the exemplary embodiment of the present invention holds the communication with other information processing system via the radio LAN technology, the RF-ID technology, or the like, for example, and then executes the processing to receive the data from other information processing system, transmit the image described by the user to other information processing system, and the like. The electronic paper as the information processing system according to this exemplary embodiment is constructed to include a controlling portion 121, a storing portion 122, a displaying portion 123, a reading portion 124, and a communicating portion 125, as shown in FIG. 12, for example.

The controlling portion 121 is a CPU, or the like. The controlling portion 121 is operated in compliance with a program stored in the storing portion 122, and causes the displaying portion 123 to display/output the image stored in the storing portion 122. Also, the controlling portion 121 alters the image stored in the storing portion 122 based on the contents of the user's drawing operation that the reading portion 124 recognizes.

The storing portion 122 is EEPROM (electrically erasable and programmable ROM), or the like. Programs executed by the controlling portion 121, image data to be displayed on the displaying portion 123, and the like are stored in the storing portion 122.

The displaying portion 123 is a film-like display device having flexibility, and displays the image in accordance with the instruction input from the controlling portion 121. The displaying portion 123 is constructed by laminating a base film, a fluid ink layer, and a top film. As the displaying portion 123, the image is displayed by bringing locally the ink particles in the fluid ink layer closer to the base film side or bringing locally the ink particles closer to the top film side, and the like.

The reading portion 124 recognizes the drawing operation made on the displaying portion 123 by the user and outputs the contents of the drawing operation to the controlling portion 121. As an example, this reading portion 124 consist of distance sensors that are aligned linearly along one side of the displaying portion 123, then senses distances to a pen point of the pen by respective sensors when the user moves a pen on the displaying portion 123, and then generates information of a moving locus of the user's pen on the displaying portion 123 (information of two-dimensional moving locus). Then, the reading portion 124 outputs the information of the moving locus to the controlling portion 121. The controlling portion 121 synthesizes a figure corresponding to the moving locus with the image stored in the storing portion 122, based on the information of the moving locus.

The communicating portion 125 is a network interface of the wireless LAN, a communication interface of RF-ID, or the like, and transmits the information to the designated destination in compliance with the instruction input from the controlling portion 121. Also, the communicating portion 125 receives the information that comes via the network, and outputs such information to the controlling portion 121.

One feature in this exemplary embodiment is that a bending member is contained in the film portion of the displaying portion 123.

This bending member has a hinge structure and is provided to the position in which the film portion may be bent, as shown in FIG. 13, for example. A pair of supporting portions 131a, 131b are provided to both ends of the folding line, and a shaft portion 132 that can be turned with respect to this supporting portion 131 is supported by the supporting portions 131. Also, a flexible substrate is wound on the shaft portion 132 to supply a power that is used to move the ink particles in the fluid ink layer from one side of the film portion folded by this shaft portion 132 to the other side.

Also, a sensor (e.g., a potentiometer, or the like) for sensing whether or not the shaft portion 132 is turned is provided to at least one of the supporting portions 131. An output signal of the sensor is transmitted to the controlling portion 121 via the wiring in the flexible substrate.

Then, when the user folds a part of the electronic paper by turning the shaft portion 132, the controlling portion 121 senses the folded position and executes the information processing determined previously every position. For example, this bending member is arranged in vicinity of the four corners (edge portions) of the displaying portion 123 respectively, and the contents of the information processing which are correlated with the positions of respective corner portions, like the correlation shown in FIG. 10, are stored in the storing portion 122. When the controlling portion 121 senses that the bending member is folded, such controlling portion 121 reads the information processing corresponding to the folded position from the storing portion 122. Also, the controlling portion 121 reads the image as the display object stored in the storing portion 122, and executes the information processing read from the storing portion 122 based on the image data. For example, in case the information processing of the electronic mail sending to the predetermined destination is correlated with the folded position, the controlling portion 121 sends the image data to the predetermined destination by the electronic mail via the communicating portion 125.

According to this exemplary embodiment, the operation required to send the contents drawn by a pen on the electronic paper by the electronic mail can be executed by the bending a part of the electronic paper, and thus a degree of the convenience can be improved.

In addition, the acceleration sensor may be provided to this electronic paper, and the information processing contents may be correlated with the user's operations (e.g., throwing, waving, and the like) applied to the electronic paper. Then, the operation taken by the user may be sensed by the acceleration sensor and then the corresponding information processing may be executed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information holding device comprising:
a storing portion that stores information;
a transmitting portion that transmits the information;
a sheet-like member having flexibility; and
a detecting portion that detects a change in shape of the sheet-like member, wherein
when a change in shape of the sheet-like member detected by the detecting portion satisfies a predetermined condition, the information stored in the storing portion is transmitted by the transmitting portion.

2. A communication support device comprising:
a loading surface on which an information holding device that holds information is loaded;
a detecting portion that detects a contact area of the information holding device loaded on the loading surface; and
a communication controlling portion that executes a communication process based on a time change of the contact area of the information holding device detected by the detecting portion.

3. The communication support device according to claim 2, wherein
the communication controlling portion acquires information held in the information holding device the contact area of which is changed, and executes a predetermined transmitting process of the acquired information.

4. A communication method for transmitting information stored in an information holding device that includes: a storing portion that stores information; a transmitting portion that transmits the information; a sheet-like member having flexibility; and a detecting portion that detects a change in shape of the sheet-like member, the communication method comprising:
transmitting the information stored in the storing portion, when the change in shape of the sheet-like member detected by the detecting portion satisfies a predetermined condition.

5. A storage medium readable by a computer, the storage medium storing a program of instructions executable by the computer to perform a function for controlling a communication of information with an information holding device that contains a communicating portion of executing the communication of information and a sheet-like member having flexibility, the function comprising:
controlling a communication established by the communicating portion based on a change in shape of the sheet-like member.

6. An information processing device comprising:
a recognizing unit that recognizes a shape altering operation applied to a sheet-like member that holds information; and
a processing unit that applies an information processing determined previously to correspond to the recognized shape altering operation to the information held by the sheet-like member.

7. An information processing method comprising:
recognizing a shape altering operation applied to a sheet-like member that holds information; and
applying an information processing determined previously to correspond to the recognized shape altering operation to the information held by the sheet-like member.

8. A storage medium readable by a computer, the storage medium storing a program of instructions executable by the computer to perform a function for processing information, the function comprising:
recognizing a shape altering operation applied to a sheet-like member that holds information; and
applying an information processing determined previously to correspond to the recognized shape altering operation to the information held by the sheet-like member.
